(19) United States
(12) Patent Application Publication
(10) Pub. No.: US 2009/0252903 A1
(43) Pub. Date: Oct. 8, 2009

(54) HEAT-SENSITIVE TRANSFER SHEET

(75) Inventors: Shinichi Teramae, Minami-ashigara-shi (JP); Hideyuki Shirai, Minami-ashigara-shi (JP); Hisato Nagase, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/415,292

(22) Filed: Mar. 31, 2009

(30) Foreign Application Priority Data
Mar. 31, 2008 (JP) 2008-089334

(51) Int. Cl. B41M 5/40

(52) U.S. Cl. 428/32.86

(57) ABSTRACT

A heat-sensitive transfer sheet having a substrate and a thermal transfer layer containing a thermal-transferable dye, a binder, and a release agent on one surface of the substrate, and a heat-resistant lubricating layer formed on the other surface of the substrate,

in which the dye has at least one kind of a specific dye; the binder comprises at least one selected from the group consisting of a polyamide-series resin, a polyester-series resin, an epoxy-series resin, a polyurethane-series resin, a polyacrylic resin, a vinyl-series resin, a petroleum-series resin, a rosin derivative, a coumarone-indene resin, a terpene-series resin, a polyolefin-series resin, a polyvinyl butyral-series resin, and a polyvinyl acetoacetal-series resin; and the release agent is at least one kind of a polymer-type release agent having a molecular weight of from 5,000 to 100,000 and having a fluorine atom-substituted aliphatic group on its side chain.

### FIELD OF THE INVENTION

The present invention relates to a heat-sensitive transfer sheet. In particular, the present invention relates to a heat-sensitive transfer sheet excellent in release property, in the case where the period of time from coating to drying for manufacturing is short.

### BACKGROUND OF THE INVENTION

Various heat transfer recording methods have been known so far. Among these methods, dye diffusion transfer recording systems attract attention as a process that can produce a color hard copy having an image quality closest to that of silver halide photography. Moreover, this system has advantages over silver halide photography: it enables direct visualization from digital data; it makes reproduction simple, and the like without treatment chemicals.

Among these methods, in a sublimation type thermal transfer recording system, a heat-sensitive transfer sheet (hereinafter also referred to as an ink sheet) containing dyes is superposed on a heat-sensitive transfer image-receiving sheet (hereinafter also referred to as an image-receiving sheet), and then the heat-sensitive transfer sheet is heated for example, by a thermal head whose exothermic action is controlled by electric signals, in order to transfer the dyes contained in the heat-sensitive transfer sheet to the heat-sensitive transfer image-receiving sheet, thereby recording an image information. Three colors: cyan, magenta, and yellow, are used for recording a color image by overlapping one color to other, thereby enabling transferring and recording a color image having continuous gradation for color densities.

As one of the technical subjects to be solved in the sublimation-type thermal transfer recording system, there is pointed out an image defect that is caused by release failures between the heat-sensitive transfer sheet and the heat-sensitive transfer image receiving sheet. In the sublimation-type thermal transfer recording system, the heat-sensitive transfer sheet is superposed on the heat-sensitive transfer image receiving sheet to form an image. The image is formed on the heat-sensitive transfer image receiving sheet, and therefore, after image formation, it is necessary to separate the unneeded heat-sensitive transfer sheet from the heat-sensitive transfer image receiving sheet without leaving any unneeded substances on the heat-sensitive transfer image receiving sheet. However, from a requirement of reduction in printing period of time, there is a trend that a temperature applied to the heat-sensitive transfer sheet at the time of recording increases (a heating period of time is reduced in keeping with this trend). Consequently, this trend is easy to cause a problem such as a fusion of the heat-sensitive transfer sheet and the heat-sensitive image receiving sheet after printing, or a generation of separation residue lines by a discontinuous separation of the heat-sensitive transfer sheet from the heat-sensitive transfer image receiving sheet.

For preventing a fusion of the heat-sensitive transfer sheet and the heat-sensitive transfer image receiving sheet, several methods of using a release agent such as a silicon compound or a fluorine compound have been proposed. As one of these methods, a method of introducing such the release agent into the image receiving sheet has been proposed. However, in a recent sublimation-type thermal transfer recording system, a transparent resin is laminated, in many cases, on the heat-sensitive transfer image receiving sheet having an image formed thereon from the standpoint of improvement in both scratch resistance and light-fastness of the formed image. In this embodiment, when a release agent is present in the heat-sensitive transfer image receiving sheet, the release agent sometimes gives disadvantages to laminating the transparent resin on the heat-sensitive transfer image receiving sheet.

As an alternative method, a method of introducing the release agent into the heat-sensitive transfer sheet has been proposed. A method of introducing a fluorine-series polymer as the release agent has been also proposed (see Japanese Patent No. 3150691, JP-A-5-32072 (“JP-A” means unexamined published Japanese patent application), JP-A-1-146791). However, this method is not satisfactory to dissolve the problem of separation residue line.

### SUMMARY OF THE INVENTION

It has been found that a release property can preferably be improved by introduction of the aforementioned fluorine-series polymer compound into the thermal transfer layer of the heat-sensitive transfer sheet, and thereby the problem of the separation residue line can be dissolved. However, new problems occurred unexpectedly.

The coating of the thermal transfer layer is performed by an ordinary method such as roll coating, bar coating, gravure coating, or gravure reverse coating. As the period of time from coating to drying for manufacturing becomes shorter, a cost merit becomes higher. However, in the case where the fluorine-based polymer is contained in a thermal transfer layer, it has been found that when the period of time from coating to drying for manufacturing is short, the release property is deteriorated. Therefore, the problem of the separation residue line cannot be dissolved.

The present invention resides in a heat-sensitive transfer sheet having:

a substrate,
a thermal transfer layer containing a thermal-transferable dye, a binder, and a release agent, on one surface of the substrate, and
a heat-resistant lubricating layer formed on the other surface of the substrate,
wherein the dye has at least one kind of dye represented by formula (1),
wherein the binder has at least one selected from the group consisting of a polyamide-series resin, a polyester-series resin, an epoxy-series resin, a polyurethane-series resin, a polyacrylic resin, a vinyl-series resin, a petroleum-series resin, a rosin derivative, a coumarone-indene resin, a terpene-series resin, a polyolefin-series resin, a polyvinyl butyral-series resin, and a polyvinyl acetacetal-series resin, and
wherein the release agent is at least one kind of a polymer-type release agent having a molecular weight of from 5,000 to 100,000 and having a fluorine atom-substituted aliphatic group on its side chain;

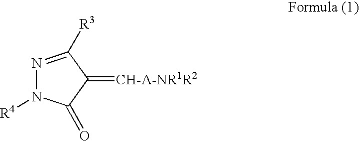

wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted alkyl group, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group.

Other and further features and advantages of the invention will appear more fully from the following description.

### DETAILED DESCRIPTION OF THE INVENTION

According to the present invention, there is provided the following means:

(1) A heat-sensitive transfer sheet having:
a substrate,
a thermal transfer layer containing a thermal-transferable dye, a binder, and a release agent, on one surface of the substrate, and
a heat-resistant lubricating layer formed on the other surface of the substrate,
wherein the dye has at least one kind of dye represented by formula (1),
wherein the binder has at least one selected from the group consisting of a polyamide-series resin, a polyester-series resin, an epoxy-series resin, a polyurethane-series resin, a polyacrylic resin, a vinyl-series resin, a petroleum-series resin, a rosin derivative, a coumarone-indene resin, a terpene-series resin, a polyolefin-series resin, a polyvinyl butyral-series resin, and a polyvinyl acetacetal-series resin, and
wherein the release agent is at least one kind of a polymer-type release agent having a molecular weight of from 5,000 to 100,000 and having a fluorine atom-substituted aliphatic group on its side chain;

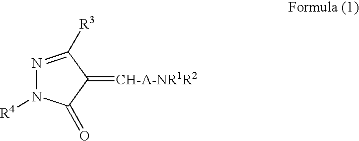

wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group;

(2) The heat-sensitive transfer sheet described in the above item (1), wherein the binder is a polyvinyl acetacetal-series resin.
(3) The heat-sensitive transfer sheet described in the above item (1), wherein a content of an acetal moiety to the total polyvinyl acetacetal-series resin is 50% by mass or more.

The present invention is explained in detail below.

First, the heat-sensitive transfer sheet for use in the present invention is explained in detail.

The heat-sensitive transfer sheet for use in the present invention has a substrate and a thermal transfer layer containing a diffusion transfer dye (hereinafter, referred to as heat-sensitive thermal transfer layer or dye layer) formed thereon, and preferably has a transferable protective layer laminate formed on the same substrate, for forming a protective layer composed of a transparent resin on a thermally transferred image by thermal transfer and thus covering and protecting the image.

In the heat-sensitive transfer sheet in the present invention, preferably, thermal transfer layers in individual colors of yellow, magenta and cyan, and an optional thermal transfer layer in black are repeatedly provided onto a single substrate in area order in such a manner that the colors are divided from each other. An example of the thermal transfer layers is an embodiment wherein dye layers in individual colors of yellow, magenta and cyan are coated onto a single substrate in the longitudinal direction of the substrate in area order, correspondingly to the area of the recording surface of the above-mentioned heat-sensitive transfer image-receiving sheet, in such a manner that the colors are divided from each other. In addition to the three layers above, it may have a black thermal transfer layer. In addition, the heat-sensitive transfer sheet preferably has a mark indicating the start point of each of various colors allowing recognition by the printer used.

In the heat-sensitive transfer sheet, dyes of individual colors are coated on a substrate in the state of dispersion in which each dye is dispersed in a binder.

The binder that is used in the heat-sensitive transfer sheet of the present invention contains at least one kind selected from a group consisting of a polyamide-series resin, a polyester-series resin, an epoxy-series resin, a polyurethane-series resin, a polyacrylic resin, a vinyl-series resin, a petroleum-series resin, a rosin derivative, a coumarone-indene resin, a terpene-series resin, a polyolefin-series resin, a polyvinyl butyral-series resin, and a polyvinyl acetacetal-series resin. These resins may be used as a mixture or a copolymer thereof. The proportion of the above-described resins relative to the total binder content is 50% by mass or more, preferably 70% by mass or more, and more preferably 90% by mass or more. Various kinds of known resins may be used within the range of the present invention. In the case where the proportion of the above-described resins relative to the total binder content is too small, effects of the present invention tend to become difficult to be achieved. Of these binders, the polyvinyl acetacetal-series resin is more preferable. A preferable composition of the acetacetal-series resin in the present invention is that the content of the acetal moiety to the total resin content is 50% by mass or more, preferably 65% by mass or more, and more preferably 80% by mass or more, and the acetacetal content of the acetal moiety is 70% by mass or more, preferably 80% by mass or more, and more preferably 90% by mass or more. With respect to the acetal moiety, acetacetal and other acetal (for example, butyral, benzal) may be mixed within the range of the present invention.

The aforementioned acetal-series resin can be synthesized according to a method that is described in Japanese Patent No. 3065111 and references cited in its specification. Further, of these resins, there are marketed products that are commercially available, for example, ESLEC KS-5 (trade name, manufactured by Sekisui Chemical Co., Ltd.), and DENKA BUTYRAL #5000-D (trade name, manufactured by DENKI KAGAKU KOGYOU K.K.).

The heat-sensitive transfer sheet of the present invention contains a polymer-type release agent having fluorine atom-substituted aliphatic groups on its side chains in the thermal transfer layer. The polymer-type release agent having fluorine atom-substituted aliphatic groups on its side chains can be derived from a fluorine atom-substituted aliphatic compound (compound having a fluorine atom-substituted aliphatic group(s) on the side chain(s)) produced by a telomerization method (also referred to as a telomer method), or an oligomerization method (also referred to as an oligomer method). The fluorine atom-substituted aliphatic compound can be easily synthesized, for example, by a method described in JP-A-2002-90991.

The fluorine atom-substituted aliphatic group is an aliphatic group having at least one substituted fluorine atom (straight-chain, branched or cyclic aliphatic group), preferably an alkyl, alkenyl or cycloalkynyl group having 1 to 36 carbon atoms, more preferably an alkyl group having 1 to 36 carbon atoms (preferably 1 to 18 carbon atoms, more preferably 1 to 12 carbon atoms, furthermore preferably 1 to 10 carbon atoms, most preferably 4 to 8 carbon atoms) and the aliphatic group may be substituted additionally with a substituent other than the fluorine atom. Examples of the substituent include alkyl groups, aryl groups, heterocyclic groups, halogen atoms other than the fluorine atom, hydroxyl groups, alkoxy groups, aryloxy groups, alkylthio groups, arylthio groups, amino groups, alkylamino groups, arylamino groups, heterocyclic amino groups, acylamino groups, sulfone amino groups, carbamoyl groups, sulfamoyl groups, cyano groups, nitro groups, acyl groups, sulfonyl groups, ureido groups, and urethane groups.

In the present invention, the fluorine atom-substituted aliphatic group is most preferably a perfluoroalkyl group.

The polymer-type release agent having fluorine atom-substituted aliphatic groups on the side chains is preferably a polymer or copolymer of a monomer containing a fluorine atom-substituted aliphatic group, and preferred examples of the monomers include acrylic acid derivatives (e.g., acrylic acids, acrylic esters, and acrylamides, preferably acrylic esters and acrylamides, more preferably acrylic esters) and methacrylic acid derivatives (e.g., methacrylic acids, methacrylic esters, and methacrylamides, preferably methacrylic esters and methacrylamides, more preferably methacrylic esters) each having an acyl moiety, alcohol moiety or amide moiety (a substituent bonding with the nitrogen atom) substituted with a fluorine atom-substituted aliphatic group; and acrylonitrile derivatives having a fluorine atom-substituted aliphatic group.

In the case where the polymer-type release agent having fluorine atom-substituted aliphatic groups on the side chains is a copolymer with a fluorine atom-substituted aliphatic group-containing monomer, examples of the monomer used in combination include acrylates, methacrylates, acrylonitriles, acrylamides, methacrylamides, olefins, and styrenes. Among these, acrylates, methacrylates, acrylonitriles, acrylamides, and methacrylamides are preferable; acrylates and methacrylates are more preferable; and among them, those having a polyoxyalkylene (e.g., polyoxyethylene, polyoxypropylene) unit in the group substituted on the alcohol moiety or the amide nitrogen atom are preferable.

In the present invention, the polymer above is preferably a copolymer, which may be a binary copolymer or a ternary or higher copolymer.

As the polymer-type release agents having a fluorine atom-substituted aliphatic group on its side chains, preferred are copolymers of a monomer having an aliphatic group substituted with a fluorine atom and (poly(oxyalkylene))acrylate and/or (poly(oxyalkylene))methacrylate. They may be random copolymers or block copolymers. Examples of the poly(oxyalkylene) group include poly(oxyethylene) group, poly(oxypropylene) group, and poly(oxybutylene) group. Further, the poly(oxyalkylene) group may be a unit having alkylene groups of chain lengths different from each other in the same chain, such as poly(block connector of oxyethylene, oxypropylene and oxyethylene) and poly(block connector of oxyethylene and oxypropylene). Further, the copolymer of a monomer having an aliphatic group substituted with a fluorine atom and (poly(oxyalkylene))acrylate (or methacrylate) is not limited to binary copolymers, but may be ternary or more multiple copolymers that can be produced by copolymerizing several different monomers such as monomers having two or more different substituted aliphatic groups substituted with a fluorine atom and two or more different kinds of (poly(oxyalkylene))acrylate (or methacrylate).

A mass-average molecular weight of the polymer compounds having an aliphatic group substituted with a fluorine atom on its side chains ranges preferably from 5,000 to 100,000, more preferably from 8,000 to 50,000, and further preferably from 10,000 to 30,000.

Examples of the copolymers include copolymers of acrylate (or methacrylate) having a perfluorobutyl group (—C₄F₉) and (poly(oxyalkylene))acrylate (or methacrylate); copolymers of acrylate (or methacrylate) having a perfluorobutyl group, (poly(oxyethylene))acrylate (or methacrylate) and (poly(oxypropylene))acrylate (or methacrylate); copolymers of acrylate (or methacrylate) having a perfluorohexyl group (—C₆F₁₃) and (poly(oxyalkylene))acrylate (or methacrylate); copolymers of acrylate (or methacrylate) having a perfluorohexyl group, (poly(oxyethylene))acrylate (or methacrylate) and (poly(oxypropylene))acrylate (or methacrylate); copolymers of acrylate (or methacrylate) having a perfluorooctyl group (—C₈F₁₇) and (poly(oxyalkylene))acrylate (or methacrylate); and copolymers of acrylate (or methacrylate) having a perfluorooctyl group, (poly(oxyethylene))acrylate (or methacrylate) and (poly(oxypropylene))acrylate (or methacrylate).

Further, the polymer-type release agents having an aliphatic group substituted with a fluorine atom on its side chains in the present invention are commercially available as a general name such as “perfluoroalkyl-containing oligomers”. For example, the following products can be used.

As the products of Dainippon Ink & Chemicals Incorporated, there are Megafac F-470, Megafac F-471, Megafac F-472SF, Megafac F-474, Megafac F-475, Megafac F-477, Megafac F-478, Megafac F-479, Megafac F-480SF, Megafac F-472, Megafac F-483, Megafac F-484, Megafac F-486, Megafac F-487, Megafac F-489, Megafac F-172D, Megafac F-178K, Megafac F-178RM (each product name). As the products of Sumitomo 3 M Limited, there are Novec™ FC-4430 and FC-4432 (each product name).

The addition amount of the polymer compound having a fluorine atom-substituted aliphatic group on its side chain may be properly determined in accordance with the kind and amount of both dye and binder, and preferably in the range of 0.01% to 20%, more preferably from 0.1% to 10%, and further preferably from 0.2% to 5%, relative to a total solid content (by mass) of the thermal transfer layer.

The dye represented by formula (1) for use in the thermal transfer sheet of the present invention is explained in detail below.

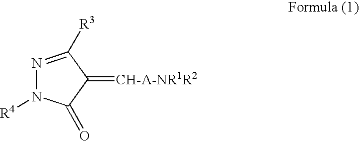

In formula (1), A represents a substituted or unsubstituted-phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group.

Here, the substituents which the groups represented by A, R¹, R², R³, and R⁴ may have will be more specifically described.

Hereinafter, such substituents will be illustrated below with reference to typical and preferred examples thereof. Any of such substituents is a substituent which each of the above groups may have.

The halogen atom that A, R¹, R², R³, and R⁴ may have includes a fluorine atom, a chlorine atom, a bromine atom, and an iodine atom. Of these, a chlorine atom and a bromine atom are preferable, a chlorine atom is particularly preferable.

The aliphatic group that A, R¹, R², R³, and R⁴ may have includes a linear, branched or cyclic aliphatic group. The term “cyclic aliphatic group” means cyclic aliphatic group, such as a cycloalkyl group, a cycloalkenyl group, a cycloalkynyl group, a bicycloalkyl group and the like. The saturated aliphatic group includes an alkyl group, a cycloalkyl group and bicycloalkyl group and these groups may have a substituent. The carbon numbers of these substituents is preferably from 1 to 30. Examples of the alkyl group include a methyl group, an ethyl group, an n-propyl group, an isopropyl group, a t-butyl group, an n-octyl group, an eicosyl group, a 2-chloroethyl group, a 2-cyanoethyl group, a benzyl group or a 2-ethylhexyl group. The cycloalkyl group includes a substituted or unsubstituted cycloalkyl group. The substituted or unsubstituted cycloalkyl group is preferably a cycloalkyl group having 3 to 30 carbon atoms. Examples of the cycloalkyl group include a cyclohexyl group, a cyclopentyl group and a 4-n-dodecylcyclohexyl group. The bicycloalkyl group includes a substituted or unsubstituted bicycloalkyl group having 5 to 30 carbon atoms, i.e., a monovalent group obtained by removing one hydrogen atom from a bicycloalkane having 5 to 30 carbon atoms. Examples of the bicycloalkyl group include a bicyclo[1,2,2]heptan-2-yl group or a bicyclo[2,2,2]octan-3-yl group, and a tricyclo or higher structure having three or more ring structures.

The unsaturated aliphatic group that A, R¹, R², R³, and R⁴ may have represents a linear, branched, or cyclic unsaturated aliphatic group. The unsaturated aliphatic group includes an alkenyl group, a cycloalkenyl group, a bicycloalkenyl group and an alkynyl group. The alkenyl group represents a linear, branched, or cyclic substituted or unsubstituted alkenyl group. The alkenyl group is preferably a linear, branched, or cyclic substituted or unsubstituted alkenyl group having 2 to 30 carbon atoms. Examples of the alkenyl group include a vinyl group, an allyl group, a prenyl group, a geranyl group, or an oleyl group. The cycloalkenyl group is preferably a substituted or unsubstituted cycloalkenyl group having 3 to 30 carbon atoms, i.e., a monovalent group obtained by removing one hydrogen atom from a cycloalkene having 3 to 30 carbon atoms. Examples of the cycloalkenyl group include a 2-cyclopenten-1-yl group or a 2-cyclohexen-1-yl group. The bicycloalkenyl group includes a substituted or unsubstituted bicycloalkenyl group, and preferably a substituted or unsubstituted bicycloalkenyl group having 5 to 30 carbon atoms, i.e., a monovalent group obtained by removing one hydrogen atom from a bicycloalkene having one double bond. Examples of the bicycloalkenyl group include a bicyclo[2,2,1]hept-2-en-1-yl group or a bicyclo[2,2,2]oct-2-en-4-yl group. The alkynyl group is preferably a substituted or unsubstituted alkynyl group having 2 to 30 carbon atoms, e.g., an ethynyl group, or a propargyl group.

The aryl group that A, R¹, R², R³, and R⁴ may have is preferably a substituted or unsubstituted aryl group having 6 to 30 carbon atoms, e.g., a phenyl group, a p-tolyl group, a naphthyl group, an m-chlorophenyl group, or an o-hexadecanoylaminophenyl group. The aryl group is more preferably a phenyl group which may have a substituent(s).

The heterocyclic group that A, R¹, R², R³, and R⁴ may have, is a monovalent group obtained by removing one hydrogen atom from a substituted or unsubstituted, aromatic or nonaromatic heterocyclic compound, which may be condensed to another ring. The heterocyclic group is preferably a 5- or 6-membered heterocyclic group. The hetero atom(s) constituting the heterocyclic group is preferably an oxygen atom, a sulfur atom, or a nitrogen atom. The heterocyclic group is more preferably a 5- or 6-membered aromatic heterocyclic group having 3 to 30 carbon atoms. The hetero ring in the heterocyclic group are exemplified below: a pyridine ring, a pyrazine ring, a pyridazine ring, a pyrimidine ring, a triazine ring, a quinoline ring, an isoquinoline ring, a quinazoline ring, a cinnoline ring, a phthalazine ring, a quinoxaline ring, a pyrrole ring, an indole ring, a furan ring, a benzofuran ring, a thiophene ring, a benzothiophene ring, a pyrazole ring, an imidazole ring, a benzimidazole ring, a triazole ring, an oxazole ring, a benzoxazole ring, a thiazole ring, a benzothiazole ring, an isothiazole ring, a benzisothiazole ring, a thiadiazole ring, an isoxazole ring, a benzisoxazole ring, a pyrrolidine ring, a piperidine ring, a piperazine ring, an imidazolidine ring and a thiazoline ring.

The aliphatic oxy group (as a representative example, an alkoxy group) that A, R¹, R², R³, and R⁴ may have includes a substituted or unsubstituted aliphatic oxy group (as a representative example, alkoxy group). The substituted or unsubstituted aliphatic oxy group is preferably an aliphatic oxy group having 1 to 30 carbon atoms, e.g., a methoxy group, an ethoxy group, an isopropoxy group, an n-octyloxy group, a methoxyethoxy group, a hydroxyethoxy group, or a 3-carboxypropoxy group.

The aryloxy group that A, R¹, R², R³, and R⁴ may have is preferably a substituted or unsubstituted aryloxy group having 6 to 30 carbon atoms, e.g., a phenoxy group, a 2-methylphenoxy group, a 4-t-butylphenoxy group, a 3-nitrophenoxy group, or a 2-tetradecanoylaminophenoxy group. The aryloxy group is more preferably a phenoxy group which may have a substituent.

The acyloxy group that A, R¹, R², R³, and R⁴ may have is preferably a formyloxy group, a substituted or unsubstituted alkylcarbonyloxy group having 2 to 30 carbon atoms, or a substituted or unsubstituted arylcarbonyloxy group having 6 to 30 carbon atoms, e.g., a formyloxy group, an acetyloxy group, a pivaloyloxy group, a stearoyloxy group, a benzoyloxy group, or a p-methoxyphenylcarbonyloxy group.

The carbamoyloxy group that A, R¹, R², R³, and R⁴ may have is preferably a substituted or unsubstituted carbamoyloxy group having 1 to 30 carbon atoms, e.g., an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group.

The aliphatic oxy carbonyloxy group (as a representative example, an alkoxycarbonyloxy group) that A, R¹, R², R³, and R⁴ may have is preferably an aliphatic oxy carbonyloxy group having 2 to 30 carbon atoms. The aliphatic oxy carbonyloxy group may have a substituent(s). There can be exemplified a methoxycarbonyloxy group, an ethoxycarbonyloxy group, a t-butoxycarbonyloxy group, or an n-octylcarbonyloxy group.

The aryloxycarbonyloxy group that A, R¹, R², R³, and R⁴ may have is preferably a substituted or unsubstituted aryloxycarbonyloxy group having 7 to 30 carbon atoms, e.g., a phenoxycarbonyloxy group, a p-methoxyphenoxycarbonyloxy group, or a p-n-hexadecyloxyphenoxycarbonyloxy group. The aryloxycarbonyloxy group is more preferably a phenoxycarbonyloxy group which may have a substituent(s).

The amino group that A, R¹, R², R³, and R⁴ may have includes an unsubstituted amino group, an aliphatic amino group (as a representative example, an alkylamino group), an arylamino group, and a heterocyclic amino group. The amino group is preferably a substituted or unsubstituted aliphatic amino group (as a representative example, alkylamino group) having 1 to 30 carbon atoms, or a substituted or unsubstituted arylamino group having 6 to 30 carbon atoms, e.g., an amino group, a methylamino group, a dimethylamino group, an anilino group, an N-methyl-anilino group, a diphenylamino group, a hydroxyethylamino group, a carboxyethylamino group, a sulfoethylamino group, a 3,5-dicarboxyanilino group, or a 4-quinolylamino group.

The acylamino group that A, R¹, R², R³, and R⁴ may have is preferably a formylamino group, a substituted or unsubstituted alkylcarbonylamino group having 1 to 30 carbon atoms, or a substituted or unsubstituted arylcarbonylamino group having 6 to 30 carbon atoms, e.g., a formylamino group, an acetylamino group, a pivaloylamino group, a lauroylamino group, a benzoylamino group, or a 3,4,5-tri-n-octyloxyphenylcarbonylamino group.

The aminocarbonylamino group that A, R¹, R², R³, and R⁴ may have is preferably a substituted or unsubstituted aminocarbonylamino group having 1 to 30 carbon atoms, e.g., a carbamoylamino group, an N,N-dimethylaminocarbonylamino group, an N,N-diethylaminocarbonylamino group, or a morpholinocarbonylamino group. In the aminocarbonylamino group, the term “amino” has the same meaning as “amino” in the above-described amino group.

The aliphatic oxy carbonylamino group (as a representative example, alkoxycarbonylamino group) that A, R¹, R², R³, and R⁴ may have is preferably a substituted or unsubstituted aliphatic oxy carbonylamino group having 2 to 30 carbon atoms, e.g., a methoxycarbonylamino group, an ethoxycarbonylamino group, a t-butoxycarbonylamino group, an n-octadecyloxycarbonylamino group, or an N-methyl-methoxycarbonylamino group. The aliphatic oxy carbonylamino group may have a substituent(s).

The aryloxycarbonylamino group that A, R¹, R², R³, and R⁴ may have is preferably a substituted or unsubstituted aryloxycarbonylamino group having 7 to 30 carbon atoms, e.g., a phenoxycarbonylamino group, a p-chlorophenoxycarbonylamino group, or an m-n-octyloxyphenoxycarbonylamino group. The aryloxycarbonylamino group is more preferably a phenoxycarbonylamino group which may have a substituent(s).

The sulfamoylamino group that A, R¹, R², R³, and R⁴ may have is preferably a substituted or unsubstituted sulfamoylamino group having 0 to 30 carbon atoms, e.g., a sulfamoylamino group, an N,N-dimethylaminosulfonylamino group, or an N-n-octylaminosulfonylamino group.

The aliphatic- (as a representative example, alkyl-) or aryl-sulfonylamino group that A, R¹, R², R³, and R⁴ may have is preferably a substituted or unsubstituted aliphatic sulfonylamino group (as a representative example, alkylsulfonylamino group) having 1 to 30 carbon atoms, or a substituted or unsubstituted arylsulfonylamino group (preferably a phenylsulfonylamino group which may have a substituent(s)) having 6 to 30 carbon atoms, e.g., a methylsulfonylamino group, a butylsulfonylamino group, a phenylsulfonylamino group, a 2,3,5-trichlorophenylsulfonylamino group, or a p-methylphenylsulfonylamino group.

The aliphatic thio group (as a representative example, alkylthio group) that A, R¹, R², R³, and R⁴ may have is preferably a substituted or unsubstituted alkylthio group having 1 to 30 carbon atoms, e.g., a methylthio group, an ethylthio group, or an n-hexadecylthio group.

The sulfamoyl group that A, R¹, R², R³, and R⁴ may have is preferably a substituted or unsubstituted sulfamoyl group having 0 to 30 carbon atoms, e.g., an N-ethylsulfamoyl group, an N-(3-dodecyloxypropyl)sulfamoyl group, an N,N-dimethylsulfamoyl group, an N-acetylsulfamoyl group, an N-benzoylsulfamoly group, or an N—(N′-phenylcarbamoyl)sulfamoyl group.

The aliphatic- (as a representative example, alkyl-) or aryl-sulfinyl group that A, R¹, R², R³, and R⁴ may have is preferably a substituted or unsubstituted aliphatic sulfinyl group (as a representative example, alkylsulfinyl group) having 1 to 30 carbon atoms, or a substituted or unsubstituted arylsulfinyl group (preferably a phenylsulfinyl group which may have as substituent(s)) having 6 to 30 carbon atoms, e.g., a methylsulfinyl group, an ethylsulfinyl group, a phenylsulfinyl group, or a p-methylphenylsulfinyl group.

The aliphatic- (as a representative example, alkyl-) or aryl-sulfonyl group that A, R¹, R², R³, and R⁴ may have is preferably a substituted or unsubstituted aliphatic-sulfonyl group (as a representative example, alkylsulfonyl group) having 1 to 30 carbon atoms, or a substituted or unsubstituted arylsulfonyl group (preferably a phenylsulfonyl group which may have a substituent(s)) having 6 to 30 carbon atoms, e.g., a methylsulfonyl group, an ethylsulfonyl group, a phenylsulfonyl group, or a p-toluenesulfonyl group.

The acyl group that A, R¹, R², R³, and R⁴ may have is preferably a formyl group, a substituted or unsubstituted aliphatic carbonyl group (as a representative example, alkylcarbonyl group) having 2 to 30 carbon atoms, a substituted or unsubstituted arylcarbonyl group (preferably a phenylcarbonyl group which may have a substituent(s)) having 7 to 30 carbon atoms, or a substituted or unsubstituted heterocyclic carbonyl group having 4 to 30 carbon atoms and being bonded to said carbonyl group through a carbon atom, e.g., an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group.

The aryloxycarbonyl group that A, R¹, R², R³, and R⁴ may have is preferably a substituted or unsubstituted aryloxycarbonyl group having 7 to 30 carbon atoms, e.g., a phenoxycarbonyl group, an o-chlorophenoxycarbonyl group, an m-nitrophenoxycarbonyl group, or a p-t-butylphenoxycarbonyl group. The aryloxycarbonyl group is more preferably a substituted or unsubstituted phenoxycarbonyl group which may have a substituent(s).

The aliphatic oxycarbonyl group (as a representative example, alkoxycarbonyl group) that A, R¹, R², R³, and R⁴ may have is preferably a substituted or unsubstituted aliphatic oxycarbonyl group having 2 to 30 carbon atoms, e.g., a methoxycarbonyl group, an ethoxycarbonyl group, a t-butoxycarbonyl group, or an n-octadecyloxycarbonyl group. The aliphatic oxycarbonyl group may have a substituent(s).

The carbamoyl group that A, R¹, R², R³, and R⁴ may have is preferably a substituted or unsubstituted carbamoyl group having 1 to 30 carbon atoms, e.g., a carbamoyl group, an N-methylcarbamoyl group, an N,N-dimethylcarbamoyl group, an N,N-di-n-octylcarbamoyl group, or an N-(methylsulfonyl)carbamoyl group.

Examples of the aryl- or heterocyclic-azo group that A, R¹, R², R³, and R⁴ may have include a phenylazo group, a 4-methoxyphenylazo group, a 4-pivaloylaminophenylazo group, and a 2-hydroxy-4-propanoylphenylazo group.

Examples of the imido group that A, R¹, R², R³, and R⁴ may have include an N-succinimido group and an N-phthalimido group.

In addition to these substituents, examples of the substituent that A, R¹, R², R³, and R⁴ may have include a hydroxyl group, a cyano group, a nitro group, a sulfo group, a carboxyl group, and the like.

These groups may each further have a substituent. Examples of the substituent include the above-mentioned substituents.

A is preferably a substituted or unsubstituted phenylene group; more preferably a phenylene group substituted by a methyl group or a chlorine atom, or an unsubstituted phenylene group; and more preferably an unsubstituted phenylene group.

R¹ is preferably a substituted or unsubstituted alkyl group (preferably an alkyl group having 1 to 8 carbon atoms), an allyl group, or a substituted or unsubstituted aryl group (preferably an aryl group having 6 to 10 carbon atoms); more preferably a substituted or unsubstituted alkyl group (preferably an alkyl group having 1 to 6 carbon atoms), or an allyl group; further preferably a substituted or unsubstituted alkyl group (preferably an alkyl group having 1 to 4 carbon atoms); and most preferably an ethyl group.

R² is preferably a substituted or unsubstituted alkyl group (preferably an alkyl group having 1 to 8 carbon atoms), an allyl group, or a substituted or unsubstituted aryl group (preferably an aryl group having 6 to 10 carbon atoms); more preferably a substituted or unsubstituted alkyl group (preferably an alkyl group having 1 to 6 carbon atoms), or an allyl group; further preferably a substituted or unsubstituted alkyl group (preferably an alkyl group having 1 to 4 carbon atoms); and most preferably an ethyl group.

R³ is preferably a substituted or unsubstituted amino group, or a substituted or unsubstituted alkoxy group; more preferably a dialkylamino group (preferably a dialkylamino group having 2 to 8 carbon atoms), an unsubstituted amino group, or an unsubstituted alkoxy group (preferably an alkoxy group having 1 to 6 carbon atoms); further preferably a dialkylamino group (preferably a dialkylamino group having 2 to 4 carbon atoms), or an unsubstituted alkoxy group (preferably an alkoxy group having 1 to 4 carbon atoms); furthermore preferably an unsubstituted alkoxy group (preferably an alkoxy group having 1 to 4 carbon atoms); and most preferably an ethoxy group.

R⁴ is preferably a substituted or unsubstituted alkyl group having 1 to 8 carbon atoms, or a substituted or unsubstituted aryl group (preferably an aryl group having 6 to 10 carbon atoms); more preferably a substituted or unsubstituted alkyl group having 1 to 6 carbon atoms, or a substituted or unsubstituted aryl group (preferably an unsubstituted aryl group, further preferably an unsubstituted aryl group having 6 to 10 carbon atoms); further preferably a substituted or unsubstituted aryl group (preferably an aryl group having 6 to 10 carbon atoms); furthermore preferably a substituted unsubstituted phenyl group; and most preferably an unsubstituted phenyl group.

The following is an explanation about a preferable combination of various substituents (atoms) that a dye represented by formula (1) may have (combination of A, R¹, R², R³ and R⁴): A preferred dye is a dye in which at least one of the substituents is the above-described preferable substituent. A more preferred dye is a dye in which most of various substituents are the above-described preferable substituents. The most preferred dye is a dye in which all substituents are the above-described preferable substituents.

Examples of a preferred combination of A, R¹, R², R³ and R⁴ in the dye represented by the formula (1) include combinations wherein A is a substituted or unsubstituted phenylene group, R¹ is a substituted or unsubstituted alkyl group having 1 to 8 carbon atoms, an allyl group, or a substituted or unsubstituted aryl group having 6 to 10 carbon atoms, R² is a substituted or unsubstituted alkyl group having 1 to 8 carbon atoms, an allyl group, or a substituted or unsubstituted aryl group having 6 to 10 carbon atoms, R³ is a substituted or unsubstituted amino group, or a substituted or unsubstituted alkoxy group, and R⁴ is a substituted or unsubstituted alkyl group having 1 to 8 carbon atoms, or a substituted or unsubstituted aryl group having 6 to 10 carbon atoms.

In more preferred combinations thereof, A is a substituted or unsubstituted phenylene group, R¹ is a substituted or unsubstituted alkyl group having 1 to 6 carbon atoms, an allyl group, or a substituted or unsubstituted phenyl group, R² is a substituted or unsubstituted alkyl group having 1 to 6 carbon atoms, an allyl group, or a substituted or unsubstituted phenyl group, R³ is a substituted or unsubstituted amino group, or a substituted or unsubstituted alkoxy group, and R⁴ is a substituted or unsubstituted alkyl group having 1 to 6 carbon atoms, or a substituted or unsubstituted phenyl group.

In the most preferred combinations thereof, A is a phenylene group substituted by a methyl group or a chlorine atom, or an unsubstituted phenylene group, R¹ is a substituted or unsubstituted alkyl group having 1 to 4 carbon atoms, or an allyl group, R² is a substituted or unsubstituted alkyl group having 1 to 4 carbon atoms, or an allyl group, R³ is a substituted or unsubstituted amino group, or a substituted or unsubstituted alkoxy group, and R⁴ is a substituted or unsubstituted phenyl group.

Specific examples of compounds as the dyes represented by the formula (1) are illustrated below. However, the dyes represented by the formula (1) should not be restrictedly interpreted by the specific examples illustrated below.

TABLE 1
Dyes represented by formula (1)

| Exemplified | | | | | |
|---|---|---|---|---|---|
| Compound | A | R¹ | R² | R³ | R⁴ |
| 1-1 | 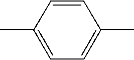 | Ethyl | Ethyl | Ethoxy | Phenyl |
| 1-2 | 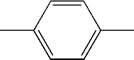 | Ethyl | Ethyl | Dimethylamino | Phenyl |
| 1-3 | 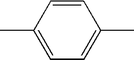 | n-Propyl | n-Propyl | Ethoxy | Phenyl |
| 1-4 | 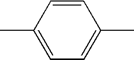 | n-Butyl | n-Butyl | Ethoxy | Phenyl |

Among the dyes represented by formula (1), commercially unavailable ones can be synthesized by a general dehydration-condensation reaction between a pyrazolone derivative and an aminobenzaldehyde derivative.

Colorants can be used together with the dyes for use in the present invention. Such colorants are not particularly limited, so far as the colorants are able to diffuse by heat and able to be incorporated in a heat-sensitive transfer sheet, and able to transfer by heat from the heat-sensitive transfer sheet to an image-receiving sheet. The dyes that have been conventionally used for the heat-sensitive transfer sheet or known dyes can be used.

Preferable examples of the dyes to be used together include diarylmethane-series dyes, triarylmethane-series dyes, thiazole-series dyes, methine-series dyes such as merocyanine; azomethine-series dyes typically exemplified by indoaniline, acetophenoneazomethine, pyrazoloazomethine, imidazole azomethine, imidazo azomethine, and pyridone azomethine; xanthene-series dyes; oxazine-series dyes; cyanomethylene-series dyes typically exemplified by dicyanostyrene, and tricyanostyrene; thiazine-series dyes; azine-series dyes; acridine-series dyes; benzene azo-series dyes; azo-series dyes such as pyridone azo, thiophene azo, isothiazole azo, pyrol azo, pyralazo, imidazole azo, thiadiazole azo, triazole azo, and disazo; spiropyran-series dyes; indolinospiropyran-series dyes; fluoran-series dyes; rhodaminelactam-series dyes; naphthoquinone-series dyes; anthraquinone-series dyes; and quinophthalon-series dyes.

Specific examples of the colarants to be used together with the dye used in the present invention are exemplified below. Specific examples of the yellow dyes include Disperse Yellow 231, Disperse Yellow 201 and Solvent Yellow 93. Of these, Solvent Yellow 93 is particularly preferable. Specific examples of the magenta dyes include Disperse Violet 26, Disperse Red 60, and Solvent Red 19. Of these, Disperse Violet 26 and Disperse Red 60 are particularly preferable. Specific examples of the cyan dyes include Solvent Blue 63, Solvent Blue 36, Disperse Blue 354 and Disperse Blue 35. Of these, Solvent Blue 63 is particularly preferable. As a matter of course, it is also possible to use suitable dyes other than these dyes as exemplified above.

Further, dyes each having a different hue from each other as described above may be arbitrarily combined together. For instance, a black hue can be obtained from a combination of dyes.

The dye represented by formula (1) is contained in a yellow thermal transfer layer preferably in a range of 0.1% by mass to 80% by mass, and more preferably 0.5% by mass to 70% by mass. In the case where the dye is contained in a magenta or cyan thermal transfer layer, the dye is preferably contained in a range of 0.1% by mass to 5% by mass, and more preferably 0.5% by mass to 2% by mass. In the case where the proportion of the dye contained in a magenta or cyan thermal transfer layer is to large, color reproduction tends to deteriorate.

A dye is contained in a thermal transfer layer preferably in an amount of 20% by mass to 80% by mass, and more preferably 30% by mass to 70% by mass. The ratio of the dye to the binder (dye/binder) is preferably from 0.3 to 2.5, and more preferably from 0.5 to 2.0.

The heat-sensitive transfer sheet of the present invention contains a dye, a binder, and a polymer-type release agent having a fluorine atom-substituted aliphatic group at on its side chain in a thermal transfer layer. The heat-sensitive thermal transfer layer may further contain waxes, silicones, polymer particles and inorganic particles, in accordance with necessity.

The thermal transfer layer may be disposed on a substrate according to a method of dispersing or dissolving a dye, a binder, a polymer-type release agent having a fluorine atom-substituted aliphatic group at on its side chain, waxes, silicones, polymer particles, inorganic particles, and the like in a solvent to prepare an ink composition for forming a thermal transfer layer, and then applying the resultant ink composition on the substrate according to an ordinary coating method such as roll coating, bar coating, gravure coating, and gravure reverse coating. As the solvent, any known ink solvent may be used without any particular limitation. Of the solvents, methyl ethyl ketone or toluene is preferable in consideration of solubility, stability of the ink composition and the like. The density of the ink composition for forming the thermal transfer layer is preferably in a range of 1% by mass to 50% by mass, and more preferably 5% by mass to 30% by mass.

It is preferable from the standpoint of production cost that the period of time from coating to drying of a thermal transfer layer-forming ink composition on a substrate is as short as possible. The period of time is preferably 60 seconds or less, and more preferably 10 seconds or less, and most preferably 3 seconds or less. In the present invention, the condition that the amount of a solvent remaining in the thermal transfer layer is 1000 ppm or less is defined as a dry condition.

The coating amount of the heat transfer layer is preferably from 0.1 to 2.0 g/m², more preferably from 0.2 to 1.2 g/m² (the amount is a numerical value converted to the solid content in the layer; any coating amount in the following description is a numerical value converted to the solid content unless otherwise specified). The film thickness of the heat transfer layer is preferably from 0.1 to 2.0 μm, more preferably from 0.2 to 1.2 μm.

Each of the thermal transfer layers may have a mono-layered structure or a multi-layered structure. In the case of the multi-layered structure, the individual layers constituting the thermal transfer layer may be the same or different in composition.

In the present invention, a transferable protective layer laminate is preferably formed in area order onto the heat-sensitive transfer sheet. The transferable protective layer laminate is used to cover and protect a heat-transferred image with a protective layer composed of a transparent resin, thereby to improve durability such as scratch resistance, light-fastness, and resistance to weather. This laminate is effective in the case where the transferred dye is insufficient in image durability such as light resistance, scratch resistance, and chemical resistance in the state that the transferred dye is naked in the surface of an image-receiving sheet.

The transferable protective layer laminate can be formed by forming, onto a substrate, a releasing layer, a protective layer and an adhesive layer in this order successively. The protective layer may be formed by plural layers. In the case where the protective layer also has functions of other layers, the releasing layer and the adhesive layer can be omitted. It is also possible to use a support on which an easy adhesive layer has already been formed.

In the present invention, as a transferable protective layer-forming resin, preferred are resins that are excellent in scratch resistance, chemical resistance, transparency and hardness. Examples of the resin include polyester resins, acrylic resins, polystyrene resins, polyurethane resins, acrylic urethane resins, silicone-modified resins of the above-described resins, ultraviolet-shielding resins, mixtures of these resins, ionizing radiation-curable resins, and ultraviolet-curing resins. Particularly preferred are polyester resins and acrylic resins. These resins may be crosslinked with various crosslinking agents.

In the heat-sensitive transfer sheet of the present invention, it is preferred to dispose a heat-resistant lubricating layer (sometimes referred to also as a back side layer) on the surface (back side) of the substrate opposite to the dye layer coating side, namely on the same side as the surface with which a thermal head and the like. In addition, in the case of the protective layer transfer sheet, it is also preferred to dispose a back side layer on the surface (back side) of the substrate opposite to the transferable protective layer coating side, namely on the same side as the surface with which a thermal head and the like contact.

If the heat-sensitive transfer sheet is heated by a heating device such as a thermal head in the state such that the back side of the substrate of the transfer sheet directly contacts with the heating device, heat seal is apt to occur. In addition, owing to a large friction between them, it is difficult to smoothly transfer the heat-sensitive transfer sheet at the time of copying.

The heat-resistant lubricating layer is disposed so that the heat-sensitive transfer sheet enables to withstand heat energy from a thermal head. The heat-resistant lubricating layer prevents the heat seal, and enables a smooth travel action. Recently, the necessity of the heat-resistant lubricating layer is becoming greater on account that the heat energy from a thermal head is increasing in association with speeding-up of the printer.

The heat-resistant lubricating layer is formed by coating a composition wherein additives such as a sliding agent, a lubricant, a surfactant, inorganic particles, organic particles, and pigments are added to a binder. Further, an interlayer may be disposed between the heat-resistant lubricating layer and the substrate. As the interlayer, there has been known a layer containing inorganic fine particles and a water-soluble resin or a hydrophilic resin capable of emulsification.

A heat-sensitive transfer image-receiving sheet that can be used for forming an image in the present invention will be described in detail hereinafter.

The heat-sensitive transfer image-receiving sheet has a support and at least one receptor layer containing a thermoplastic dye-receiving polymer formed thereon. The receptor layer may contain an ultraviolet absorbent, a releasing agent, a lubricant, an antioxidant, a preservative, a surfactant, and other additives. Between the support and the receptor layer may be formed an intermediate layer such as a heat insulating layer (porous layer), a gloss control layer, a white background adjusting layer, a charge control layer, an adhesive layer, or a primer layer. The heat-sensitive transfer image-receiving sheet preferably has at least one heat insulating layer between the support and the receptor layer.

The receptor layer and these intermediate layers are preferably formed by simultaneous multilayer coating, and a multiple number of these intermediate layers may be formed as needed.

A curling control layer, a writing layer, or a charge-control layer may be formed on the backside of the support. Each of these layers may be coated on the backside of the support by using a usual method such as a roll coating, a bar coating, a gravure coating, and a gravure reverse coating.

In the present invention, the heat-sensitive transfer image-receiving sheet contains a latex polymer having a glass transition temperature (Tg) of preferably from 20° C. to 60° C., and more preferably from 25° C. to 55° C.

In the present invention, use of a dyeable latex polymer is preferable. As a latex polymer, multiple latex polymers may be used. In such a case, at least one latex polymer is necessary to have a glass transition temperature (Tg) in the range above. Most preferably, all latex polymers contained have glass transition temperatures (Tgs) in the range above.

The latex polymer is generally a dispersion of fine particles of thermoplastic resin in a water-soluble dispersion medium. Examples of the thermoplastic resins used for the latex polymer in the present invention include polycarbonates, polyesters, polyacrylates, vinyl chloride copolymers, polyurethane, styrene-acrylonitrile copolymers, polycaprolactone and the like.

Among them, polycarbonates, polyesters, and vinyl chloride copolymers are preferable, polyesters and vinyl chloride copolymers are particularly preferable.

The polyester is prepared by condensation of a dicarboxylic acid derivative and a diol compound, and may include an aromatic ring and/or a saturated carbon ring as well as a water-soluble group for imparting dispersibility thereto.

Examples of the vinyl chloride copolymers include vinyl chloride-vinyl acetate copolymers, vinyl chloride-acrylate copolymers, vinyl chloride-methacrylate copolymers, vinyl chloride-vinyl acetate-acrylate copolymers, and vinyl chloride-acrylate-ethylene copolymers. As described above, the copolymer may be a binary copolymer or a ternary or higher copolymer, and the monomers may be distributed randomly or uniformly by block copolymerization.

The copolymer may contain a unit derived from an auxiliary monomer component such as vinylalcohol derivatives, maleic acid derivatives, and vinyl ether derivatives. The copolymer preferably contain vinyl chloride components in an amount of 50 mass % or more, and the unit derived from an auxiliary monomer component such as maleic acid derivative and vinyl ether derivative in an amount of 10 mass % or less.

The latex polymers may be used alone or as a mixture. The latex polymer may have a uniform structure or a core/shell structure, and in the latter case, the resins constituting the core and shell respectively may have different glass transition temperatures.

Examples of commercially available acrylate latexes include Nipol LX814 (Tg: 25° C.) and Nipol LX857X2 (Tg: 43° C.) (all trade names, manufactured by ZEON CORPORATION) and others.

Examples of commercially available polyester latexes include VYLONAL MD-1100 (Tg: 40° C.), VYLONAL MD-1400 (Tg: 20° C.), VYLONAL MD-1480 (Tg: 20° C.) and VYLONAL MD-1985 (Tg: 20° C.) (all trade names, manufactured by Toyobo Co. Ltd.) and others.

Examples of commercially available vinyl chloride copolymers include VINYBLAN 276 (Tg: 33° C.) and VINYBLAN 609 (Tg: 46° C.) (all trade names, manufactured by Nissin Chemical Industry Co., Ltd.), Sumielite 1320 (Tg: 30° C.) and Sumielite 1210 (Tg: 20° C.) (all trade names, manufactured by Sumika Chemtex Company, Limited) and others.

The addition amount of the latex polymer (latex polymer solid content) is preferably 50 to 98 mass %, more preferably 70 to 95 mass %, with respect to all polymers in the receptor layer. The average particle diameter of the latex polymer is preferably 1 to 50,000 nm, more preferably 5 to 1,000 nm.

In the present invention, the heat insulation layer preferably contains hollow polymer particles.

The hollow polymer particles in the present invention are polymer particles having voids inside of the particles. The hollow polymer particles are preferably aqueous dispersion containing these hollow polymer particles. Examples of the hollow polymer particles include (1) non-foaming type hollow particles obtained in the following manner: a dispersion medium such as water is contained inside of a capsule wall formed of a polystyrene, acrylic resin, styrene/acrylic resin, or the like; and, after a coating liquid is applied and dried, the water in the particles is vaporized out of the particles, with the result that the inside of each particle forms a hollow; (2) foaming type microballoons obtained in the following manner: a low-boiling-point liquid such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling-point liquid inside of the particles, whereby the inside of each particle is made to be hollow; and (3) microballoons obtained by foaming the above (2) under heating in advance, to make hollow polymer particles.

Of these, non-foaming hollow polymer particles of the foregoing (1) are preferred. If necessary, use can be made of a mixture of two or more kinds of polymer particles. Specific examples of the above (1) include Rohpake HP-1055, manufactured by Rohm and Haas Co.; SX866(B), manufactured by JSR Corporation; and Nippol MH5055, manufactured by ZEON CORPORATION (all trade names).

The average particle diameter (particle size) of the hollow polymer particles is preferably 0.1 to 5.0 μm, more preferably 0.2 to 3.0 μm, and particularly preferably 0.4 to 1.4 μm.

The hollow ratio (percentage of void) of the hollow polymer particles is preferably in the range of 20% to 70%, and particularly preferably 30% to 60%.

In the present invention, the particle size of the hollow polymer particle is calculated after measurement of the circle-equivalent diameter of the periphery of particle under a transmission electron microscope. The average particle diameter is determined by measuring the circle-equivalent diameter of the periphery of at least 300 hollow polymer particles observed under the transmission electron microscope and obtaining the average thereof. The hollow ratio of the hollow polymer particles is calculated by the ratio of the volume of voids to the volume of a particle.

As for the resin properties of the hollow polymer particles for use in the heat-sensitive transfer image-receiving sheet in the present invention, the glass transition temperature (Tg) is preferably 70° C. or higher and 200° C. or lower, more preferably 90° C. or higher and 180° C. or lower. The hollow polymer particles are particularly preferably hollow latex polymer particles.

The heat-sensitive transfer image-receiving sheet, that can be used in the method of forming an image in the present invention, may contain a water-soluble polymer in the receptor layer and/or the heat insulation layer. Herein, the “water-soluble polymer” means a polymer which dissolves, in 100 g of water at 20° C., in an amount of preferably 0.05 g or more, more preferably 0.1 g or more, further preferably 0.5 g or more.

Examples of the water-soluble polymers that can be used in the heat-sensitive transfer image-receiving sheet in the present invention include carrageenans, pectins, dextrins, gelatins, caseins, carboxymethylcelluloses, hydroxyethylcelluloses, hydroxypropylcelluloses, polyvinylpyrrolidone, polyvinylpyrrolidone copolymers, polyvinylalcohol, polyethylene glycol, polypropylene glycol, water-soluble polyesters, and the like. Among them, gelatin and polyvinylalcohol are preferable.

Gelatin having a molecular weight of 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

An ordinary crosslinking agent such as aldehyde-type crosslinking agent, N-methylol-type crosslinking agent, vinylsulfone-type crosslinking agent, or chlorotriazine-type crosslinking agent may be added to the gelatin above. Among the crosslinking agents above, vinylsulfone-type and chlorotriazine-type crosslinking agents are preferable, and typical examples thereof include bisvinylsulfonylmethylether, N,N′-ethylene-bis(vinylsulfonylacetamido)ethane, and 4,6-dichloro-2-hydroxy-1,3,5-triazine or the sodium salt thereof.

As the polyvinyl alcohol, there can be used various kinds of polyvinyl alcohols such as complete saponification products thereof, partial saponification products thereof, and modified polyvinyl alcohols. With respect to these polyvinyl alcohols, those described in Koichi Nagano, et al., “Poval”, Kobunshi Kankokai, Inc. are useful. The viscosity of polyvinyl alcohol can be adjusted or stabilized by adding a trace amount of a solvent or an inorganic salt to an aqueous solution of polyvinyl alcohol, and use may be made of compounds described in the aforementioned reference “Poval”, Koichi Nagano et al., published by Kobunshi Kankokai, pp. 144-154. For a typical example, a coated-surface quality can be improved by an addition of boric acid, and the addition of boric acid is preferable. The amount of boric acid to be added is preferably 0.01 to 40 mass %, with respect to polyvinyl alcohol.

Specific examples of the polyvinyl alcohols include completely saponificated polyvinyl alcohol such as PVA-105, PVA-110, PVA-117 and PVA-117H; partially saponificated polyvinyl alcohol such as PVA-203, PVA-205, PVA-210 and PVA-220; and modified polyvinyl alcohols such as C-118, HL-12E, KL-118 and MP-203 (all trade names, manufactured by KURARAY CO., LTD.).

In the present invention, the receptor layer of the heat-sensitive transfer image-receiving sheet may contain the polymer compound having fluorine atom-substitute aliphatic groups on its side chains described above. In such a case, it may contain a polymer compound identical with or different in kind from the polymer compound having fluorine atom-substituted aliphatic groups on its side chains contained in the heat-sensitive transfer sheet, and both cases are preferable embodiments of the present invention. It may also contain, as a releasing agent, an ordinary polyethylene wax, solid waxes such as amide wax, a silicone oil, a phosphate ester-series compound, a fluorine-series surfactant or a silicone-series surfactant.

The content of the polymer compound having fluorine atom-substituted aliphatic groups on its side chains is 0.01% to 20%, preferably 0.1% to 10% and more preferably 1% to 5%, with respect to the total solid content (mass) in the receptor layer.

In the method of forming an image in the present invention, imaging is achieved by superposing a heat-sensitive transfer sheet on a heat-sensitive transfer image-receiving sheet so that a thermal (heat) transfer layer of the heat-sensitive transfer sheet is in contact with a receptor layer of the heat-sensitive transfer image-receiving sheet and giving thermal energy in accordance with image signals given from a thermal head.

Specifically, an image-forming can be achieved by the similar manner to that as described in, for example, JP-A-2005-88545. In the present invention, a printing time is preferably less than 15 seconds, and more preferably in the range of 3 to 12 seconds, and further preferably 3 to 7 seconds, from the viewpoint of shortening a time taken until a consumer gets a print.

In order to accomplish the above-described printing time, a line speed at the time of printing is preferably 0.73 msec/line or less, and further preferably 0.65 msec/line or less. Further, from the viewpoint of improvement in transfer efficiency as one of speeding-up conditions, the maximum ultimate temperature of the thermal head at the time of printing is preferably in the range of 180° C. to 450° C., more preferably 200° C. to 450° C., and furthermore preferably 350° C. to 450° C.

The method in the present invention may be utilized for printers, copying machines and the like, which employs a heat-sensitive transfer recording system. As a means for providing heat energy in the thermal transfer, any of the conventionally known providing means may be used. For example, application of a heat energy of about 5 to 100 mJ/mm² by controlling recording time in a recording device such as a thermal printer (e.g. trade name: Video Printer VY-100, manufactured by Hitachi, Ltd.), sufficiently attains the expected result. Also, the heat-sensitive transfer image-receiving sheet for use in the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

The present invention can provide a heat-sensitive transfer sheet capable of dissolving the problem that the release property is deteriorated in the case where the period of time from coating to drying for manufacturing is short.

According to the present invention, it is possible to achieve an excellent release property of the heat-sensitive transfer sheet, although the period of time from coating to drying for manufacturing is short.

The present invention will be described in more detail based on the following examples, but the invention is not intended to be limited thereto. In the following Examples, the terms “part” and “%” are values by mass, unless they are indicated differently in particular.

### EXAMPLES

### Example 1

### Production of Heat-Sensitive Transfer Sheet

Sample 101 was prepared as follows.

A polyester film 4.5 μm in thickness (trade name: LUMIRROR 5A-F595, manufactured by Toray Industries, Inc.), that was subjected to an easy-adhesion-treatment on one surface of the film, was used as a substrate. The following back side-layer coating liquid was applied onto the substrate on the other surface that was not subjected to the easy-adhesion-treatment, so that the coating amount based on the solid content after drying would be 1 g/m². After drying, the coating liquid was cured by heat at 50° C.

Coating liquids, which will be detailed later, were used to form, onto the easily-adhesive layer coated surface of the thus-formed polyester film, individual thermal transfer layers in yellow, magenta and cyan, and a transferable protective layer laminate in area order by coating. In this way, a heat-sensitive transfer sheet was produced. The solid coating amount in each of the dye layers was set to 0.8 g/m². The period of time from coating to drying of each of the dye layers was controlled by drying temperature and dry air flow (volume) to prepare two kinds of samples, i.e., one sample prepared in 3 seconds, and the other sample prepared in 180 seconds.

In the formation of the transferable protective layer laminate, a releasing-liquid-coating liquid was coated, the resultant was dried, a protective-layer-coating liquid was coated thereon, the resultant was dried, and then an adhesive-layer-coating liquid was coated thereon.

| | |
|---|---|
| Back side layer-coating liquid | |
| Acryl-series polyol resin | 14.9 mass parts |
| (trade name: ACRYDIC A-801, manufactured by | |
| Dainippon Ink and Chemicals, | |
| Incorporated) | |
| Zinc stearate | 0.35 mass part |
| (trade name: SZ-2000, manufactured by | |
| Sakai Chemical Industry Co,, Ltd.) | |
| Phosphate ester | 0.26 mass part |
| (trade name: Phoslex A18, manufactured by | |
| Sakai Chemical Industry Co., Ltd.) | |
| Phosphate ester | 3.75 mass parts |
| (trade name: PLYSURF A217, manufactured by | |
| Dai-ichi Kogyo Seiyaku Co., Ltd.) | |
| Talc | 0.33 mass part |
| (trade name: MICRO ACE L-1, manufactured by | |
| NIPPON TALK Co., Ltd.) | |
| Magnesium oxide | 0.10 mass part |
| (trade name: STARMAG PSF, manufactured by | |
| Konoshima Chemical Co., Ltd.) | |
| Polyisocyanate | 6.31 mass parts |
| (trade name: BURNOCK D-750, manufactured by | |
| Dainippon Ink and Chemicals, Incorporated) | |
| Methyl ethyl ketone/Toluene (2/1, at mass ratio) | 74 mass parts |
| Yellow-dye-layer-coating liquid | |
| Y dye | 8.0 mass parts |
| Resin | 8.0 mass parts |
| Release agent | 0.2 mass part |
| Matting agent | 0.1 mass part |
| (trade name: Flo-thene UF, manufactured by | |
| SUMITOMO PRECISION PRODUCTS Co., Ltd.) | |
| Methyl ethyl ketone/Toluene (1/2, at mass ratio) | 83.7 mass parts |
| Magenta-dye-layer-coating liquid | |
| Y dye | 0.1 mass part |
| Dye (M-1) | 8.0 mass parts |
| Resin | 8.0 mass parts |
| Release agent | 0.2 mass part |
| Matting agent | 0.1 mass part |
| (trade name: Flo-thene UF, manufactured by | |
| SUMITOMO PRECISION PRODUCTS Co., Ltd.) | |
| Methy1 ethyl ketone/Toluene (2/1, at mass ratio) | 83.6 mass parts |
| Cyan-dye-layer-coating liquid | |
| Y dye | 0.1 mass part |
| Dye (C-1) | 8.0 mass parts |
| Resin | 8.0 mass parts |
| Release agent | 0.2 mass part |
| Matting agent | 0.1 mass part |
| (trade name: Flo-thene UF, manufactured by | |
| SUMITOMO PRECISION PRODUCTS Co., Ltd.) | |
| Methyl ethyl ketone/Toluene (2/1, at mass ratio) | 83.6 mass parts |

M-1

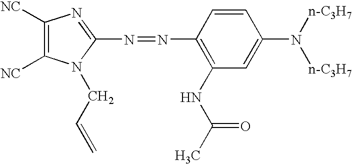

C-1

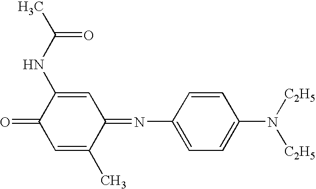

### Transferable Protective Layer Laminate

On the polyester film coated with the dye layers as described above, coating liquids of a releasing layer, a protective layer and an adhesive layer each having the following composition were coated, to form a transferable protective layer laminate. Coating amounts of the releasing layer, the protective layer and the adhesive layer after drying were 0.3 g/m², 0.5 g/m² and 2.4 g/m², respectively.

| | |
|---|---|
| Releasing-layer-coating liquid | |
| Modified cellulose resin | 4.0 mass parts |
| (trade name: L-30, manufactured by | |
| DAICEL CHEMICAL INDUSTRIES, LTD.) | |
| Methyl ethyl ketone | 96.0 mass parts |
| Protective-layer-coating liquid | |
| Acrylic resin | 30 mass parts |
| (trade name: DIANAL BR-100, manufactured by | |
| MITSUBISHI RAYON CO., LTD.) | |
| Isopropanol | 70 mass parts |
| Adhesive-layer-coating liquid | |
| Acrylic resin | 20 mass parts |
| (trade name: DIANAL BR-77, manufactured by | |
| MITSUBISHI RAYON CO., LTD.) | |
| The following ultraviolet absorber UV-1 | 0.5 mass part |
| The following ultraviolet absorber UV-2 | 3.0 mass part |
| The following ultraviolet absorber UV-3 | 3.5 mass part |
| The following ultraviolet absorber UV-4 | 3.0 mass part |
| Silicone resin fine particles | 0.06 mass part |
| (trade name: TOSPEARL 120, manufactured by | |
| MOMENTIVE Performance Materials Japan LLC.) | |
| Methyl ethyl ketone/Toluene (2/1, at mass ratio) | 70 mass parts |

(UV-1)

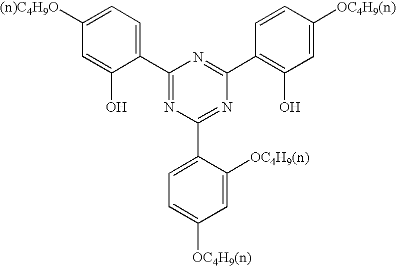

(UV-2)

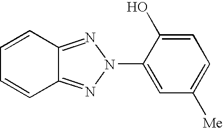

(UV-3)

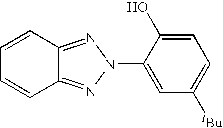

(UV-4)

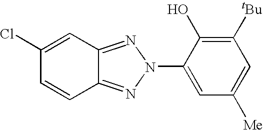

In the heat-sensitive transfer sheets 101 to 109, Y dye, resin, and release agent were contained in the yellow dye layer, the magenta dye layer and the cyan dye layer as shown in Table 2.

TABLE 2

| Heat-sensitive | | | |
|---|---|---|---|
| transfer sheet | | | |
| No. | Y dye | Resin | Release agent |
| 101 | Exemplified | Polyvinyl acetacetal resin | Polymer compound having an aliphatic group |
| | Compound 1-1 | (DENKA BUTYRAL #5000-D, trade name, | substituted with a fluorine atom on its side chains |
| | | manufactured by DENKI KAGAKU KOGYOU | (Megafac F-470, trade name, manufactured by |
| | | K.K.) | Dainippon Ink and Chemicals, Inc.) |
| 102 | Exemplified | Polyvinyl acetacetal resin | Polymer compound having an aliphatic group |
| | Compound 1-1 | (including 52 mass % acetal moiety having the | substituted with a fluorine atom on its side chains |
| | | composition of 73 mass % acetacetal and 27 | (Megafac F-470, trade name, manufactured by |
| | | mass % butyral) | Dainippon Ink and Chemicals, Inc.) |
| 103 | Exemplified | Polyvinylbutyral resin | Polymer compound having an aliphatic group |
| | Compound 1-1 | (DENKA BUTYRAL #3000-1, trade name, | substituted with a fluorine atom on its side chains |
| | | manufactured by DENKI KAGAKU KOGYOU | (Megafac F-470, trade name, manufactured by |
| | | K.K.) | Dainippon Ink and Chemicals, Inc.) |
| 104 | Phorone | Polyvinyl acetacetal resin | Polymer compound having an aliphatic group |
| | brilliant | (ESLEC KS-5, trade name, manufactured by | substituted with a fluorine atom on its side chains |
| | yellow 6GL | Sekisui Chemical Co., Ltd.) | (Megafac F-470, trade name, manufactured by |
| | (trade name) | | Dainippon Ink and Chemicals, Inc.) |
| 105 | Compound Y-1 | Polyvinyl acetacetal resin | Polymer compound having an aliphatic group |
| | described in JP- | (ESLEC KS-5, trade name, manufactured by | substituted with a fluorine atom on its side chains |
| | A-5-32072 | Sekisui Chemical Co., Ltd.) | (Megafac F-470, trade name, manufactured by |
| | | | Dainippon Ink and Chemicals, Inc.) |
| 106 | Exemplified | Cellulose acetate propionate (including 2.5% | Polymer compound having an aliphatic group |
| | Compound 1-1 | acetyl moiety and 48% propionyl moiety) | substituted with a fluorine atom on its side chains |
| | | described in Example 1 of JP-A-2-3450 | (Megafac F-470, trade name, manufactured by |
| | | | Dainippon Ink and Chemicals, Inc.) |
| 107 | Exemplified | Polyvinyl acetacetal resin | Silicone oil |
| | Compound 1-1 | (DENKA BUTYRAL #5000-D, trade name, | (trade name: KF-96-100cs, manufactured by Shin-Etsu |
| | | manufactured by DENKI KAGAKU KOGYOU | Chemical Co., Ltd.) |
| | | K.K.) | |
| 108 | Exemplified | Polyvinyl acetacetal resin | Low molecular weight type fluorine compound |
| | Compound 1-1 | (DENKA BUTYRAL #5000-D, trade name, | (trade name: Zonyl FSA, manufactured by Du Pont |
| | | manufactured by DENKI KAGAKU KOGYOU | Co.) |
| | | K.K.) | |
| 109 | Exemplified | Phenoxy resin | Low molecular weight type fluorine compound |
| | Compound 1-1 | (trade name: PKHJ, manufactured by Union | (trade name: Zonyl FSA, manufactured by Du Pont |
| | | Corbicle Corporation) | Co.) |

### (Production Method of Resin Used in Heat-Sensitive Transfer Sheet 102)

The polyvinyl acetacetal resin was produced according to the method set forth below.

First, 2790 g of pure water was poured into a separable flask having a volume of 5 liters, and 220 g of polyvinyl alcohol (degree of polymerization: 2400, number−average molecular weight: about 13.5 ten thousands, degree of saponification: 98.2 mol %) was added to the pure water so as to completely dissolve it therein. Next, while keeping a temperature of the resultant solution at 20° C., 650 g of 35% hydrochloric acid was added to the solution. After the solution temperature was reduced to 10° C., 50 g of acetaldehyde and 20 g of butylaldehyde were appropriately added to the solution to precipitate a colorless powder. Subsequently, the reaction system was heated up to 30° C. and then continued heating at the constant temperature for 3 hours. The resultant reaction system was washed and neutralized to remove both catalysis and unreacted aldehyde. Thereby polyvinyl acetacetal resin was obtained. As to the polyvinyl acetacetal resin, degree of acetalization was 51 mass %, and the content of acetacetal in the acetal was 73 mass %.

### (Preparation of Heat-Sensitive Transfer Image-Receiving Sheet (Z-1))

A paper support, on both sides of which polyethylene was laminated, was subjected to corona discharge treatment on the surface thereof, and then a gelatin undercoat layer containing sodium dodecylbenzenesulfonate was disposed on the treated surface. The subbing layer, the heat insulation layer, the lower receptor layer, and the upper receptor layer each having the following composition were multilayer-coated on the gelatin undercoat layer, in the state that the subbing layer, the heat insulation layer, the lower receptor layer, and the upper receptor layer were laminated in this order from the side of the support, by a method illustrated in FIG. 9 in U.S. Pat. No. 2,761,791. The coating was performed so that the coating amount of the subbing layer, the heat insulation layer, the lower receptor layer, and the upper receptor layer after drying would be 5.0 g/m², 9.5 g/m², 2.0 g/m², and 3.4 g/m², respectively. After drying, the multilayer-coated support was subjected to a heat treatment at 30° C. for 5 days to perform a crosslinking reaction of the gelatin with a crosslinking agent. The resultant support was processed, so that its form could fit the printer configuration, thereby to produce a heat-sensitive transfer image-receiving sheet (Z-1).

| | |
|---|---|
| Upper receptor layer | |
| Vinyl chloride-series latex (Tg: 73° C.) | 21.5 mass parts |
| (trade name: BINYBLAN 900, manufactured by | |
| Nisshin Chemicals Co., Ltd.) | |
| Vinyl chloride-series latex (Tg: 33° C.) | 1.1 mass parts |
| (trade name: VINIBLAN 276, manufactured by | |
| Nisshin Chemicals Co., Ltd.) | |
| Gelatin (10% solution) | 2.0 mass parts |
| The following ester-series wax EW-1 | 1.8 mass parts |
| The following surfactant F-1 | 0.6 mass part |
| The following surfactant F-2 | 0.4 mass part |
| Lower receptor layer | |
| Vinyl chloride-series latex (Tg: 46° C.) | 17.0 mass parts |
| (trade name: VINIBLAN 690, manufactured by | |
| Nisshin Chemicals Co., Ltd.) | |
| Vinyl chloride-series latex (Tg 73° C.) | 8.5 mass parts |
| (trade name: VINIBLAN 900, manufactured by | |
| Nisshin Chemicals Co., Ltd.) | |
| Gelatin (10% solution) | 8.5 mass parts |
| The following surfactant F-1 | 0.03 mass part |
| Heat insulation layer | |
| Acrylstyrene-series hollow latex polymer particles | 60.0 mass parts |
| (average particle diameter: 0.5 μm) | |
| (trade name: MH5055, manufactured by | |
| Nippon Zeon Co., Ltd.) | |
| Gelatin (10% solution) | 24.0 mass parts |
| Sodium salt of 2,4-dichloro-6-hydroxy-s-triazine | 0.1 mass part |
| (crosslinking agent) | |
| Interlayer 1 | |
| Polyvinyl alcohol | 7.0 mass parts |
| (trade name: POVAL PVA 205, manufactured by | |
| Kuraray) | |
| Styrene butadiene rubber latex | 52.0 mass parts |
| (trade name: SN-307, manufactured by | |
| NIPPON A & L INC) | |
| The following surfactant F-1 | 0.02 mass part |

(EW-1)

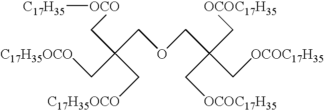

(F-1)

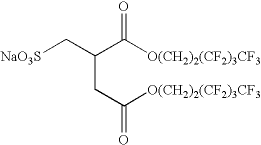

F-2

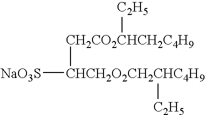

### (Verification Method of Dry State)

The dry state of the above-described heat-sensitive transfer sheet was judged by measuring an amount of the solvent remaining in the heat-sensitive transfer sheet. The remaining solvent amount was measured as described below. The heat-sensitive transfer sheet was immersed in DMF, and then the solvent was extracted from the heat-sensitive transfer sheet for 2 days at room temperature. Thereafter, the amount of the extracted solvent was measured by using a gas chromatography mass spectrometer (trade name: GCMS-QP2010, manufactured by SHIMADZU CORPORATION).

### (Evaluation of Release Property)

A combination of the above-described heat-sensitive transfer sheet and the above-described heat-sensitive transfer image-receiving sheet (Z-1) was used to evaluate print properties under the following storage/print environmental conditions. Fujifilm thermal photoprinter ASK-2000L (trade name, manufactured by FUJIFILM CORPORATION) was used as a printer for the evaluation of image-forming methods.

Samples for print were left under the storage environmental condition set forth below. Thereafter, an image of 127 mm×89 mm in size was output continuously on 30 sheets under the print environmental condition. The separation residue and fusion on the output image of from the twenty fifth sheet to the thirtieth sheet were evaluated according to the following criteria, to evaluate the print. The image included three images of a person (indoor), a person (outdoor night scene), and a solid black image was output as described above.

Storage/Print environmental condition
The heat-sensitive transfer sheet prepared as described above is stored under the environment of temperature 25° C. and humidity 55% for 1 day.
The heat-sensitive transfer sheet stored as described above, the heat-sensitive transfer image-receiving sheet, and the printer are left under the environment of temperature 30° C. and humidity 80% for 24 hours, and then printing is performed under the environment of temperature 30° C. and humidity 80% for 24 hours.

### (Evaluation Criteria of Separation Residue and Fusion)

5: No separation residue was detected by visual observation.

4: Some separation residue was detected but only to the degree allowing appreciation of image without difficulty.

3. Separation residue was intensively detected in places, and prohibited appreciation of image.

2. Separation residue appeared over the image, and prohibited appreciation of image.

1. Fusion of the heat-sensitive transfer sheet and the heat-sensitive transfer image-receiving sheet was observed, and image could not be output.

TABLE 3

| | | Release property (separation residue and | |
|---|---|---|---|
| | | fusion) | |
| Heat-sensitive | | Period of time from | Period of time from |
| transfer sheet | | coating to drying: | coating to drying: |
| No. | | 3 seconds | 180 seconds |
| 101 | Present | 5 | 5 |
| | invention 1 | | |
| 102 | Present | 4.5 | 5 |
| | invention 2 | | |
| 103 | Present | 4 | 5 |
| | invention 3 | | |
| 104 | Comparative | 2 | 5 |
| | example 1 | | |
| 105 | Comparative | 2 | 5 |
| | example 2 | | |
| 106 | Comparative | 2 | 5 |
| | example 3 | | |
| 107 | Comparative | 1 | 3 |
| | example 4 | | |
| 108 | Comparative | 1 | 2 |
| | example 5 | | |
| 109 | Comparative | 1 | 2 |
| | example 6 | | |

From Table 3, it is apparent that the heat-sensitive transfer sheets of the present invention are excellent in release property, regardless of the period from coating to drying, compared to the comparative examples.

Having described our invention as related to the present embodiments, it is our intention that the present invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2008-089334 filed in Japan on Mar. 31, 2008, which is entirely herein incorporated by reference.

What is claimed is:

1. A heat-sensitive transfer sheet comprising:
a substrate,
a thermal transfer layer containing a thermal-transferable dye, a binder, and a release agent, on one surface of the substrate, and
a heat-resistant lubricating layer formed on the other surface of the substrate,
wherein the dye comprises at least one kind of dye represented by formula (1),
wherein the binder comprises at least one selected from the group consisting of a polyamide-series resin, a polyester-series resin, an epoxy-series resin, a polyurethane-series resin, a polyacrylic resin, a vinyl-series resin, a petroleum-series resin, a rosin derivative, a coumarone-indene resin, a terpene-series resin, a polyolefin-series resin, a polyvinyl butyral-series resin, and a polyvinyl acetacetal-series resin, and
wherein the release agent is at least one kind of a polymer-type release agent having a molecular weight of from 5,000 to 100,000 and having a fluorine atom-substituted aliphatic group on its side chain; 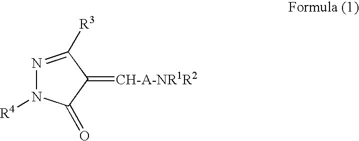
wherein A represents a substituted or unsubstituted phenylene group; R¹ and R² each independently represent a hydrogen atom, a substituted or unsubstituted alkyl group, a substituted or unsubstituted alkenyl group or a substituted or unsubstituted aryl group; R³ represents a hydrogen atom, a substituted or unsubstituted aryl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, or a substituted or unsubstituted carbamoyl group; and R⁴ represents a substituted or unsubstituted alkyl group or a substituted or unsubstituted aryl group.

2. The heat-sensitive transfer sheet according to claim 1, wherein the binder is a polyvinyl acetacetal-series resin.

3. The heat-sensitive transfer sheet according to claim 1, wherein a content of an acetal moiety to the total polyvinyl acetacetal-series resin is 50% by mass or more.
